(19) United States
(12) Patent Application Publication
(10) Pub. No.: US 2022/0229399 A1
(43) Pub. Date: Jul. 21, 2022

(54) Rotating GMT Watch Bezel With Minute Markers

(71) Applicant: David Cheung, Hong Kong (CN)

(72) Inventor: David Cheung, Hong Kong (CN)

(21) Appl. No.: 17/152,339

(22) Filed: Jan. 19, 2021

(51) Int. Cl. G04G 9/00; G04B 19/22; G04G 9/04

(52) U.S. Cl. CPC G04G 9/0076; G04G 9/045; G04B 19/225

(57) ABSTRACT

A watch bezel provides a GMT function and a count-up time-tracking function. The watch bezel includes a first set of indicia to indicate 24 hours associated with the GMT function of the watch and a second set of indicia to indicate 60 minutes in an hour. When mounted or attached to the watch casing or body, the bezel is rotatable in the clockwise direction and in the counter-clockwise direction. The watch bezel enables a user to read or set the time associated with a secondary time zone without adjusting any hands on the watch. The second set of indicia comprises a plurality of incremental minute markers and allows a user to track elapsed time. The capability of tracking elapsed time allows the watch to be used in activities that require tracking of elapsed time such as diving or other sporting events.

### CROSS-REFERENCES TO RELATED PATENT APPLICATIONS

None.

### TECHNICAL FIELD

The present disclosure relates to the field of watches and, more particularly, watch bezels.

### BACKGROUND

GMT watches are very popular and are used by pilots, world travelers and business professionals all over the world. A typical conventional GMT watch is shown in FIG. 1. A GMT watch has an additional hour hand added to the watch dial and an additional complication added to the watch gears. The additional GMT hour hand spins around the dial once per day, making it a 24-hour hand. Typically, the additional GMT hand is arrow-shaped and colored differently from the normal 12-hour hand. The GMT watch also has a rotating bezel with 24 incremental markings around the exterior to indicate 24 hours in a day. When using the GMT function on a watch, a person would refer to the number on the bezel to which the colored arrow hand is pointing. Rotating the bezel either clockwise or counter-clockwise allows a user to choose a secondary time zone.

A diver's watch is also a very popular watch and is used worldwide by divers, sportsmen and persons engaging in activities that require tracking of elapsed time. A typical conventional diver's watch is shown in FIG. 2. An important feature of the diver's watch is the rotatable bezel. The bezel on a diver's watch is also known as a “count-up” bezel. The bezel provides information about how much time has elapsed from an initial starting point. For example, a diver may rotate the bezel and align it over the minute hand before going on a dive. While diving, the minute hand will move and indicate the time the diver has been in the water. The standard length of a scuba dive is 30-50 minutes. Therefore, the first 15-20 minutes on the bezel are typically highlighted because this amount of elapsed time indicates the point in time at which the diver should return to the surface.

GMT and divers' watches come in all types of styles, colors and sizes and are manufactured by several well-known companies including Rolex®, Breitling®, Wenger®, Ferragamo® and Citizen®.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of a watch bezel are disclosed herein. The watch bezel provides both GMT and “count-up” functionality. The watch bezel includes a first set of indicia to indicate 24 hours associated with the GMT function of the watch and a second set of indicia to indicate minutes. When mounted to the watch casing or frame, the bezel is rotatable in the clockwise direction and in the counter-clockwise direction. The watch bezel enables a user to read or set the time associated with a secondary time zone without adjusting any hands on the watch. The second set of indicia, also referred to herein as “minute markers”, allows the user to track elapsed time. The capability of tracking elapsed time allows the watch to be used in activities that require tracking of elapsed time e.g. diving.

In some embodiments, the watch bezel comprises a top surface having thereon a first set of indicia representing 24 hours in a day and a second set of indicia representing 60 minutes in an hour. The first set of indicia comprises a first plurality of incremental markings that represent the 24 hours and the second set of indicia comprises a second plurality of incremental markings that represent the 60 minutes. In an embodiment, the top surface of the bezel is beveled. The watch bezel further comprises a circumferentially extending side portion. In some embodiments, the circumferentially extending side portion includes indentations or notches therein to facilitate rotation of the watch bezel.

In an embodiment disclosed herein, a watch comprises a casing, a watch dial secured to the casing, a crystal attached to the casing so as to cover the watch dial, and a single bezel rotatably attached to the casing and extending about the crystal. The single bezel has a top surface having thereon a first set of indicia representing 24 hours in a day and a second set of indicia representing 60 minutes in an hour. The first set of indicia comprises a plurality of incremental markings that represent the 24 hours and the second set of indicia comprises a plurality of incremental markings that represent the 60 minutes.

In an embodiment disclosed herein, a bezel insert comprises a top surface having thereon a first set of indicia comprising incremental markings representing 24 hours in a day and a second set of indicia comprising incremental markings representing 60 minutes in an hour.

### BRIEF DESCRIPTION OF THE DRAWINGS

FIG. 1 is a top plan view of a conventional GMT watch;

FIG. 2 is a top plan view of a conventional diver's watch;

FIG. 3 is a perspective view illustrating an embodiment of a watch bezel according to the disclosure;

FIG. 4 is a top plan view of the watch bezel of FIG. 3;

FIG. 5 is a front elevational view of the watch bezel of FIG. 3;

FIG. 6 is a rear elevational view of the watch bezel of FIG. 3;

FIG. 7 is a left side elevational view of the watch bezel of FIG. 3;

FIG. 8 is a right side elevational view of the watch bezel of FIG. 3;

FIG. 9 is a top plan view illustrating an embodiment of a watch having the watch bezel of FIG. 3 according to the disclosure;

FIG. 10 is another top plan view of the watch of FIG. 9, wherein the positions of the bezel and the GMT hand indicate time in a secondary time zone that is 15 hours behind local time;

FIG. 11 is another top plan view of the watch of FIG. 9, wherein the positions of the bezel and GMT hand indicate the time in a secondary time zone that is 4 hours ahead of local time;

FIG. 12 is another top plan view the watch of FIG. 9, wherein the minute markers on the bezel and the minute hand cooperate to indicate that 19 minutes have elapsed from the GMT zero position on the bezel;

FIG. 13 is another top plan view of the watch of FIG. 9, wherein the minute markers on the bezel and the minute hand cooperate to indicate that 39 minutes have elapsed from the GMT zero position on the bezel; and

FIG. 14 is a top plan view illustrating an embodiment of a watch bezel insert according to the disclosure.

### DETAILED DESCRIPTION

As used herein, the terms “comprises”, “comprising”, “includes”, “including”, “has”, “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

Approximating language, as used herein throughout the specification and claims, may be applied to modify any quantitative representation that could permissibly vary without resulting in a change in the basic function to which it is related. Accordingly, a value modified by a term such as “about” or “approximately” is not limited to the precise value specified.

Reference in the specification to “an exemplary embodiment”, “one embodiment” or “an embodiment” means that a particular feature, structure or characteristic described in connection with the embodiment is included in at least one embodiment of the invention. The appearances of the phrases “an exemplary embodiment”, “one embodiment” or “embodiment” in various places in the specification are not necessarily all referring to the same embodiment.

As used herein, the term “indicia” shall include signs, indications, distinguishing marks, markers or markings, numbers, Roman Numerals, Arabic numbers, letters, colors and symbols formed by any suitable method, process or technique including engraving, raised engraving, stamping, indenting, inscribing, painting, and dyeing.

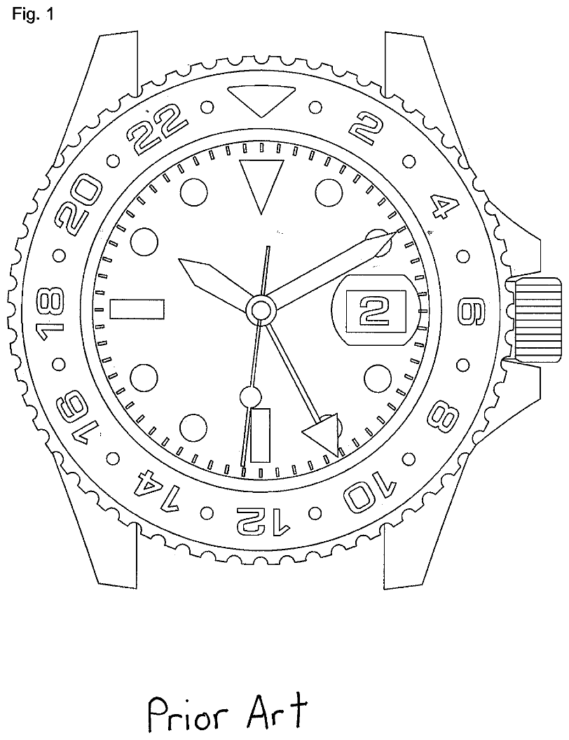

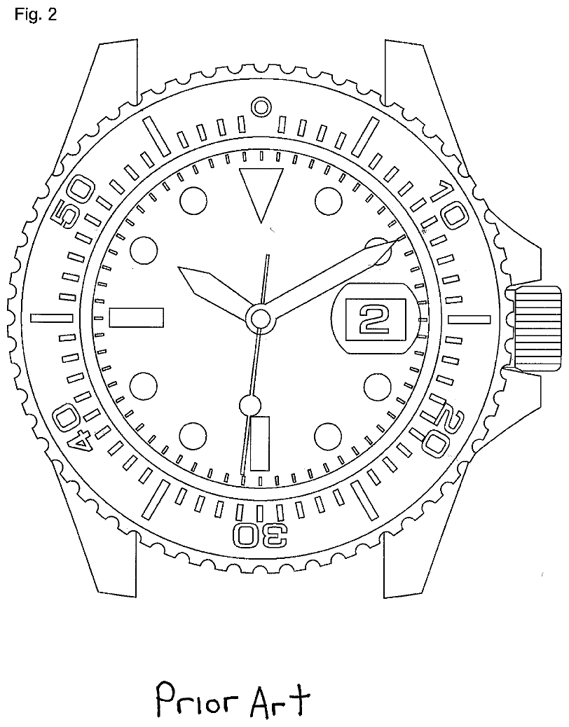

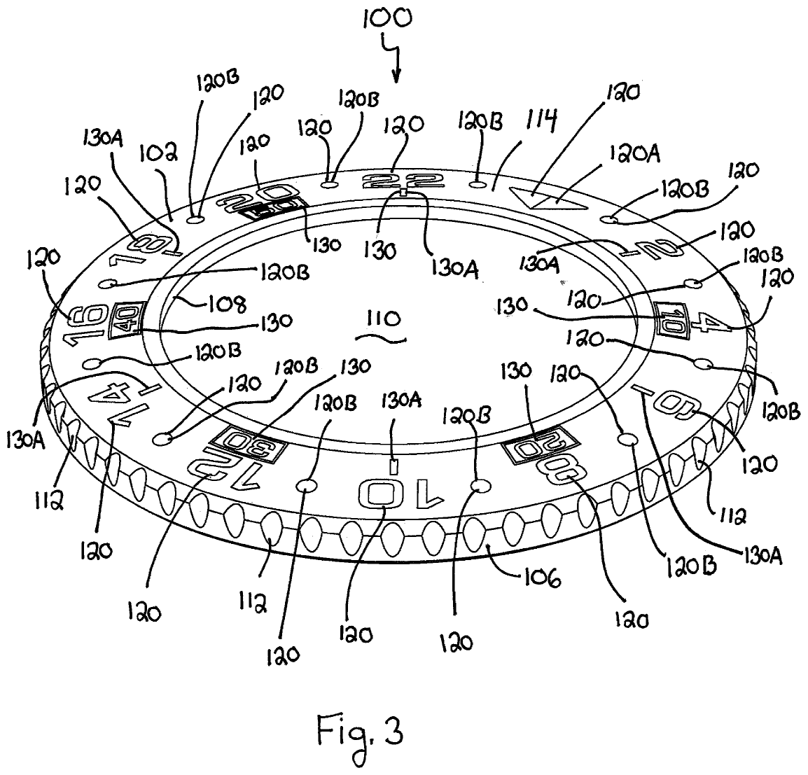

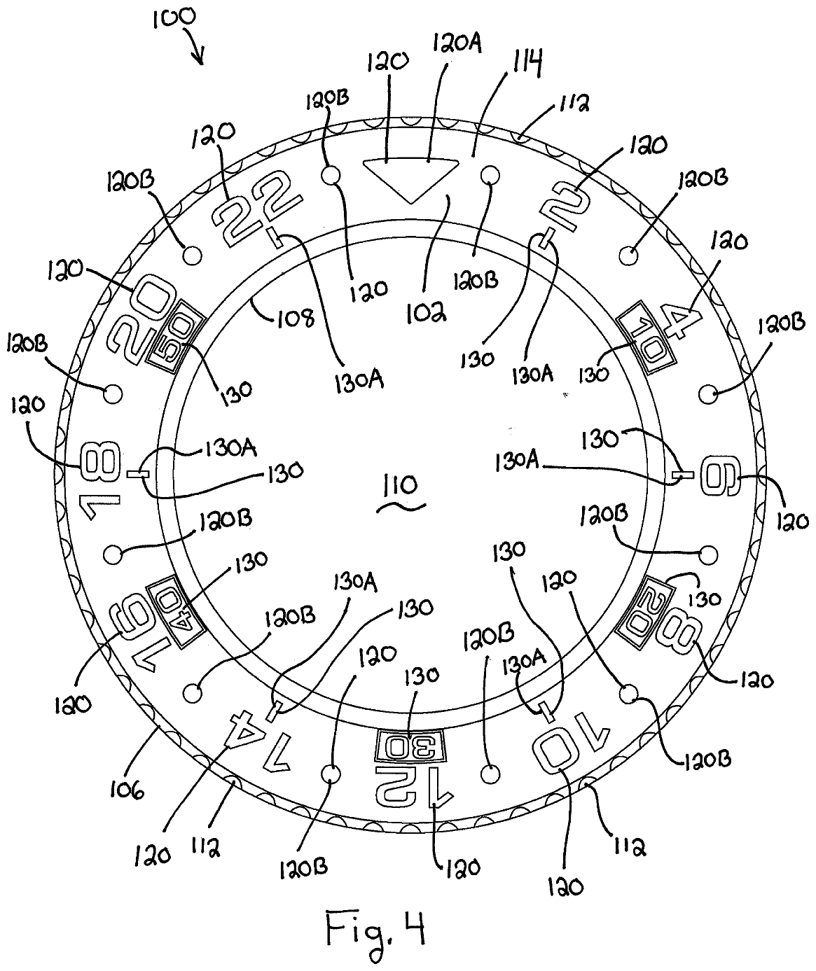

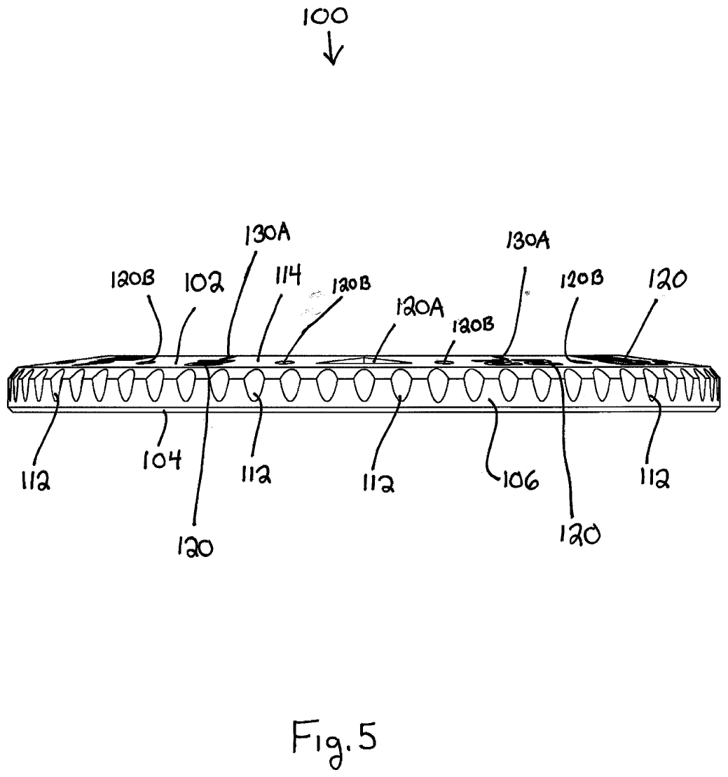

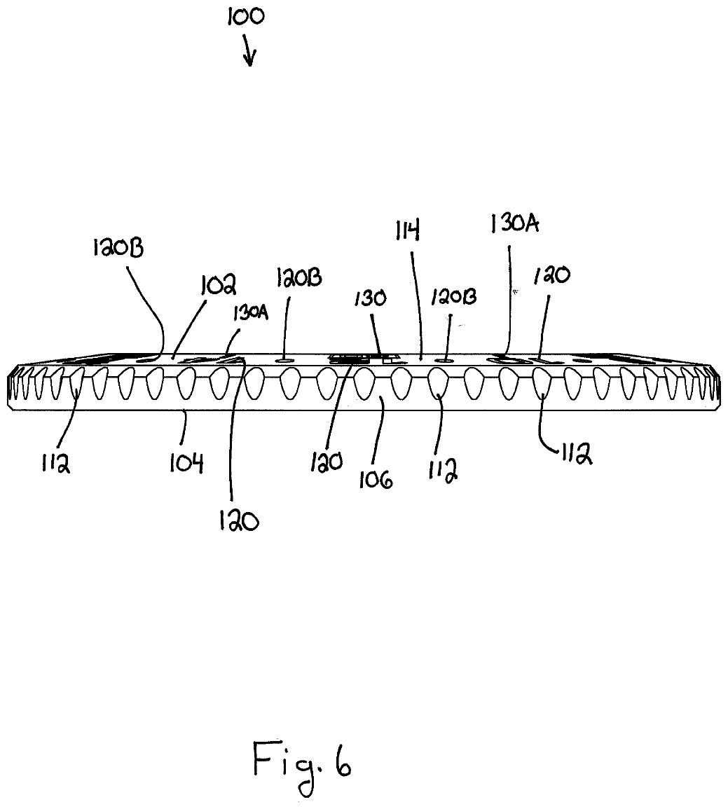

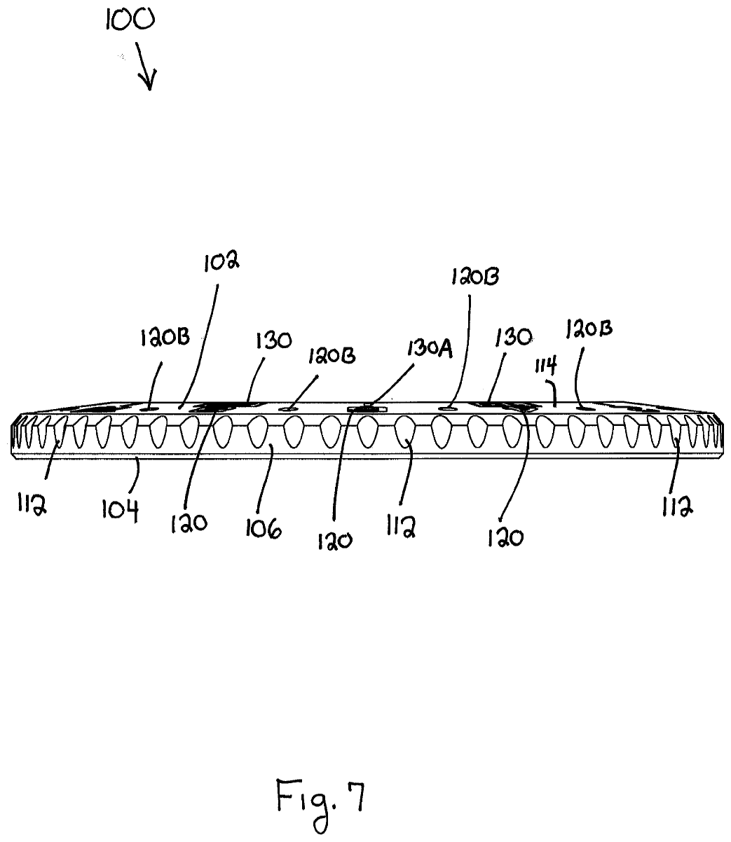

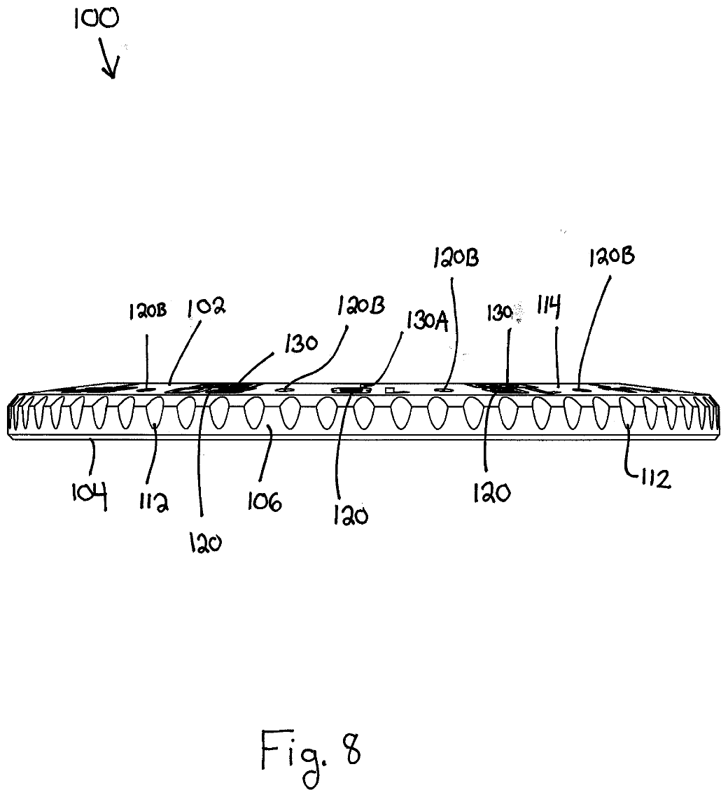

Referring to FIGS. 1-8, there is shown watch bezel 100 in accordance with an exemplary embodiment. Watch bezel 100 provides both GMT and “count-up” functionality. Thus, watch bezel 100 provides a user with the opportunity to read the time in another time zone and also to track elapsed time. Watch bezel 100 is configured to be rotatably attached to a watch casing by techniques and methods that are well-known in the art. Watch bezel 100 comprises top side 102, bottom side 104, circumferentially extending side portion 106 and inner edge or rim 108 that extends about central opening 110. In an embodiment, top side 102 is beveled in accordance with a desired angle. In an embodiment, circumferentially extending side portion 106 has a plurality of equidistantly spaced indentations or notches 112 that facilitate rotation of watch bezel 100. Top side 102 comprises top surface 114. Top surface 114 has thereon a first set of indicia comprising a plurality of incremental markings 120 representing twenty-four (24) hours in a day. Thus, the plurality of incremental markings 120 comprises twenty-four markings. The initial “zero position” in the set of incremental markings 120 is represented by an upside-down triangle 120A. In other embodiments, different indicia are used to designate the “zero position”. In order to conserve space on top surface 114, every other marking 120 is realized by a small circle, indicated by reference number 120B. However, it is to be understood that symbols other than circles may be used. The set of incremental markings 120 provides the GMT (Greenwich Mean Time) aspect of bezel 100. Thus, if a person is located in Greenwich, England, bezel 100 is rotated so that zero-position 120A points directly to the 12 o′clock position on watch dial 204. Watch dial 204 is discussed in the ensuing description. Top surface 114 has thereon a second set of indicia that comprises a plurality of incremental markings 130 that represent minutes. In an exemplary embodiment, the plurality of incremental markings 130 represents sixty minutes. Markings 130 are in increments of five minutes. Actual numbers are shown for 10, 20, 30, 40 and 50 minutes while the remaining markings 130 are shown as single lines, as indicated by reference numbers 130A. In other embodiments, different indicia may be used instead of the aforementioned “single lines”.

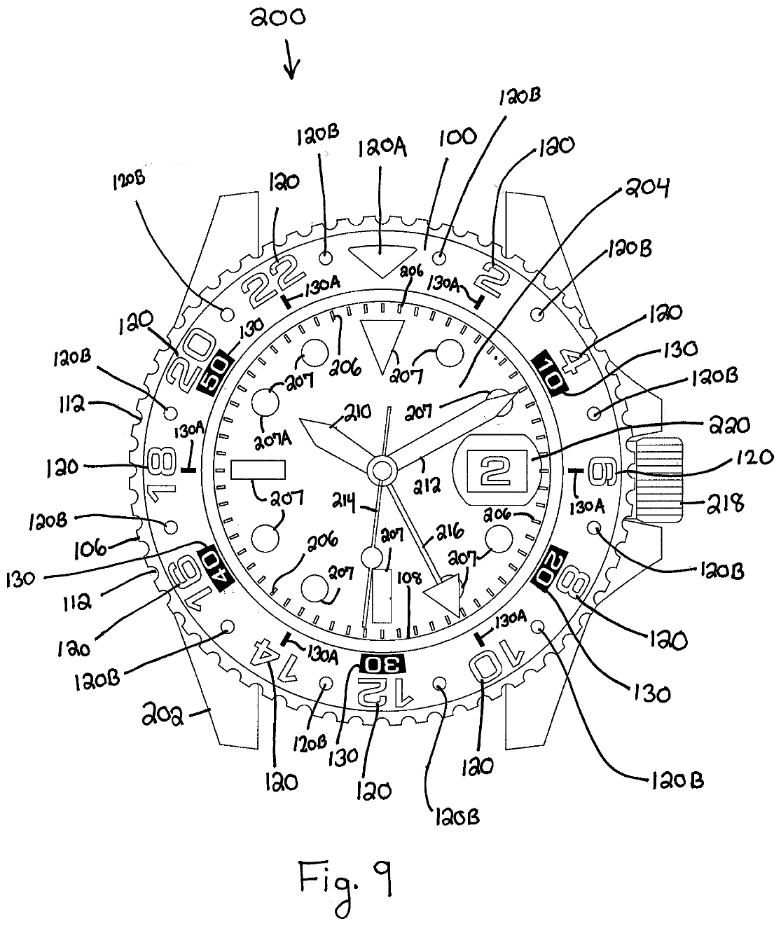

Referring to FIG. 9, there is shown watch 200 which utilizes bezel 100. Watch 200 comprises casing 202 and watch dial 204 that is secured or attached to casing 202. Watch dial 204 has minute markers 206 and hour markers 207 thereon. Watch 200 further comprises a crystal (not shown) that is attached to casing 202 and covers and protects watch dial 204. Due to the nature of the drawings of this present application, the crystal is not shown. However, watch crystals are well-known in the art and therefore, a detailed discussion of the watch crystal is not necessary. Bezel 100 is rotatably attached to casing 202 by techniques well-known in the art and holds the watch crystal (not shown) in place. The watch crystal (not shown) is positioned within central opening 110 of bezel 100. Inner rim 108 extends about the watch crystal. In some embodiments, the watch crystal is shaped so that it contacts inner rim 108 of bezel 100. Watch 200 further comprises normal hour hand 210, minute hand 212, second hand 214 and GMT hour hand 216. GMT hour hand 216 allows for the reading of time in a secondary time zone. Watch 200 further comprises crown 218 and date window 220, the functions of which are well-known in the art. Watch 200 also includes internal gears and components (not shown) for effecting movement of hands 210, 212, 214 and 216. Such internal gears and components are well known in the art and are therefore not discussed in detail herein.

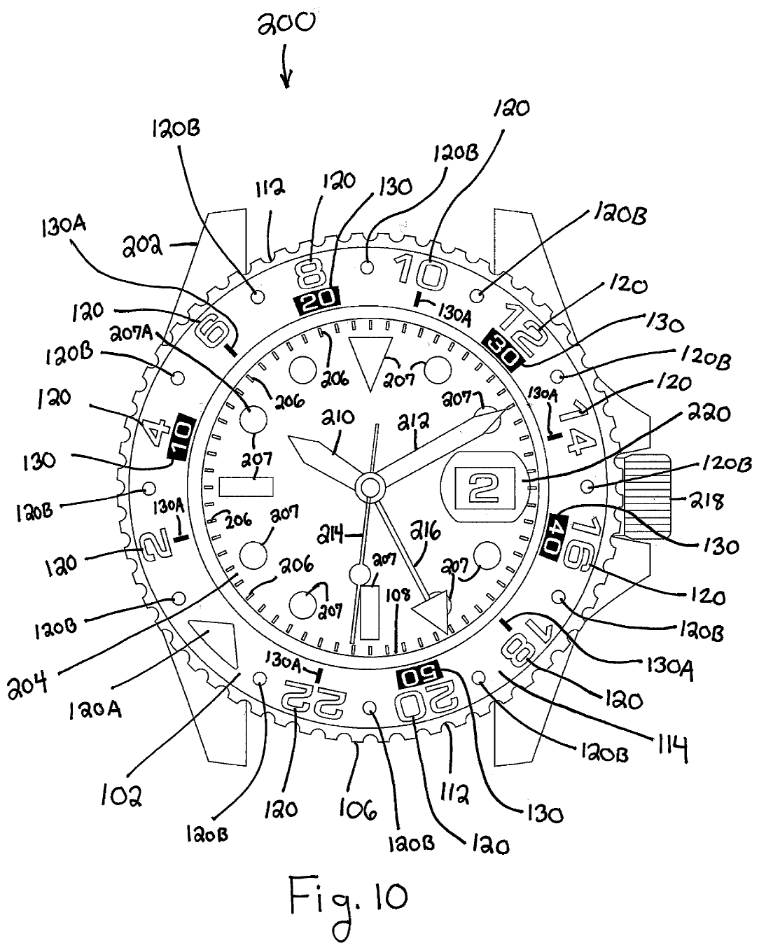

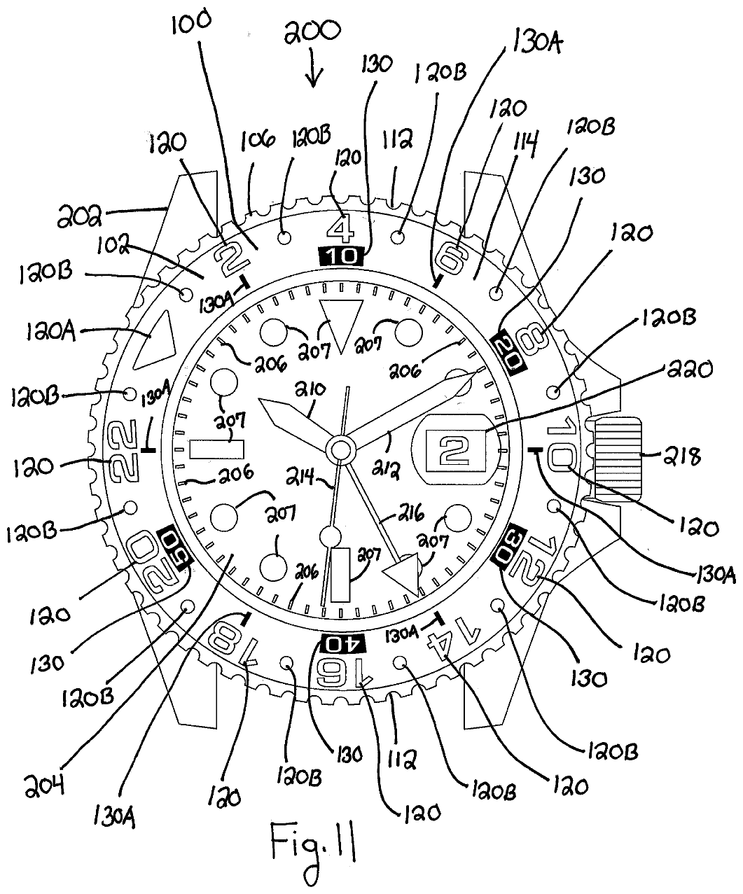

FIGS. 10 and 11 illustrate the GMT functionality of watch 200. In FIG. 10, the positions of bezel 100 and GMT hour hand 216 indicate the time in a secondary time zone that is 15 hours behind local time. In FIG. 11, the positions of bezel 100 and GMT hour hand 216 indicate the time in a secondary time zone that is 4 hours ahead of local time. FIG. 11 also illustrates the “count-up” feature of watch 200 wherein the elapsed time is twenty minutes from the zero position indicia 120A. In this example, the user wants to know when twenty (20) minutes have elapsed from the initial position of minute hand 212. In this example, minute hand 212 is initially positioned at marker 207A on watch dial 204. Marker 207A represents the number ten (10). Initially, the user would have rotated bezel 100 counter-clockwise so that zero position indicia 102A was aligned with the marker 207A. Once minute hand 212 moves to the number “20” on bezel 100, the user would know that twenty (20) minutes have elapsed.

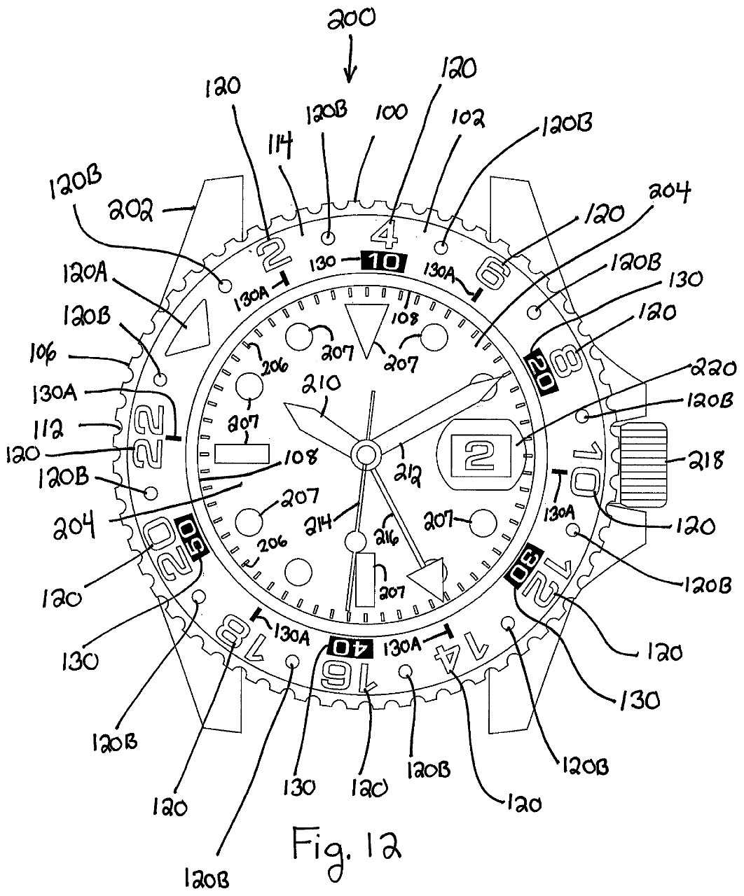

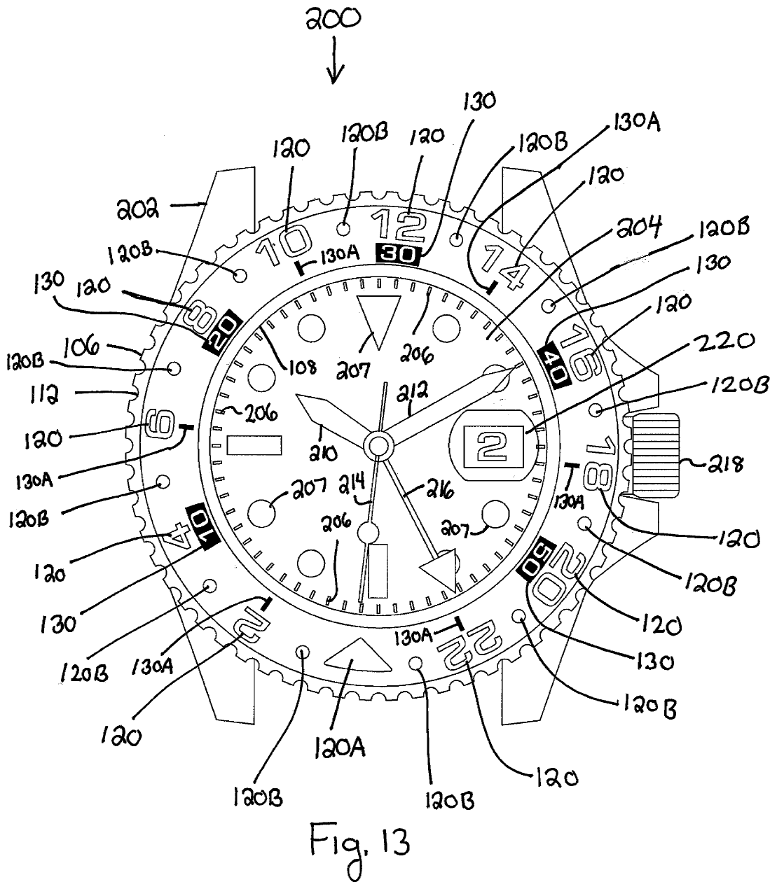

FIGS. 12 and 13 also illustrate the count-up functionality of watch 200. In FIG. 12, minute markers 130 on bezel 100 and minute hand 212 show that 19 minutes have elapsed from GMT zero position indicia 120A on bezel 100. In FIG. 13, minute markers 130 on bezel 100 and minute hand 212 show that 39 minutes have elapsed from the GMT zero position indicia 120A on bezel 100.

Watch bezel 100 may be fabricated from any one of a variety of suitable metals, including, but not limited to, stainless steel, gold, silver, copper, brass, zinc, titanium and alloys of thereof. Watch bezel 100 may also be fabricated from other materials, such as plastic, resin, ceramic and composite materials.

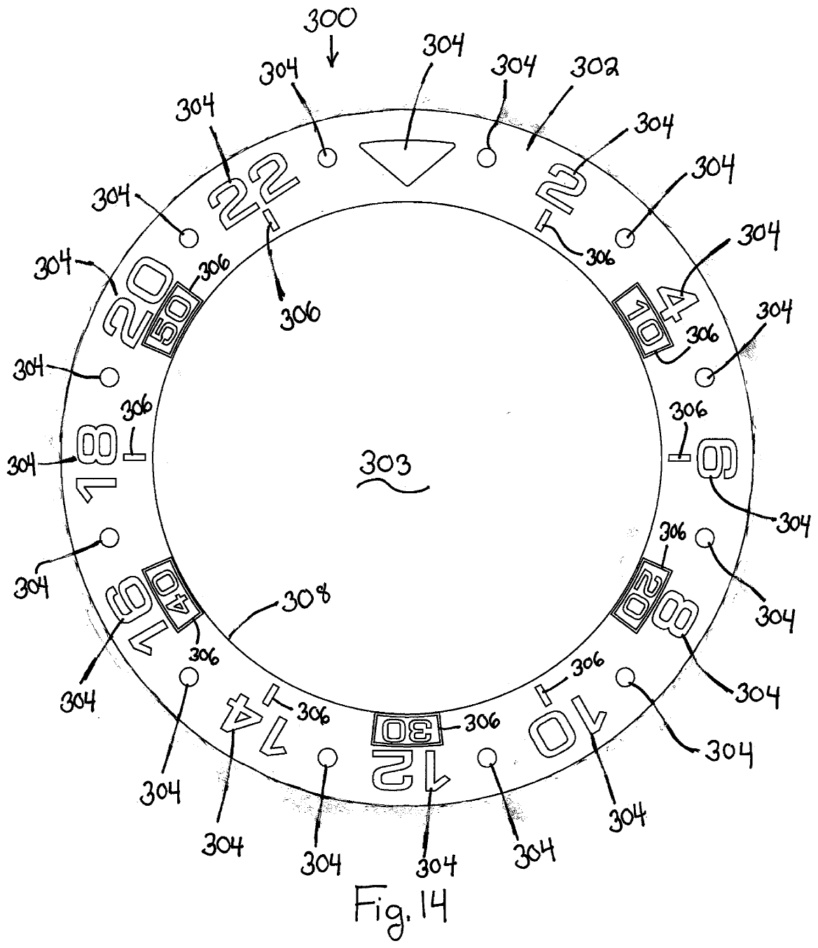

In another embodiment, the first and second sets of indicia for implementing GMT and count-up functions are provided on a bezel insert or ring that can be mounted or secured to an existing bezel frame. Such an embodiment is shown in FIG. 14. Bezel insert 300 has a top surface 302 and central opening 303 through which a watch dial may be viewed. Top surface 302 has thereon first set of indicia 304 and second set of indicia 306. First set of indicia 304 has the same function and purpose as that of first set of indicia 120 discussed in the foregoing description. Second set of indicia 306 has the same function and purpose as that of second set of indicia 130 discussed in the foregoing description. Inner edge or rim 308 extends about central opening 303. Bezel insert 300 may be fabricated from any of the materials discussed in the foregoing description.

The foregoing description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. In this regard, while the disclosed subject matter has been described in connection with various embodiments and corresponding Figures, where applicable, it is to be understood that other similar embodiments can be used or modifications and additions can be made to the described embodiments for performing the same, similar, alternative or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A watch bezel comprising a top surface having thereon a first set of indicia representing 24 hours, wherein the first set of indicia comprises a first plurality of incremental markings that represent the 24 hours, the top surface further including thereon a second set of indicia representing 60 minutes, wherein the second set of indicia comprises a second plurality of incremental markings that represent the 60 minutes.

2. The watch bezel according to claim 1 wherein the top surface is beveled.

3. The watch bezel according to claim 1 further comprising a circumferentially extending side portion having a plurality indentations therein to facilitate rotation of the watch bezel when the watch bezel is attached to a watch casing.

4. A watch comprising:
a casing;
a watch dial secured to the casing; and
a single bezel rotatably attached to the casing and having thereon a first set of indicia comprising a first plurality of incremental markings representing 24 hours in a day and a second set of indicia comprising a second plurality of incremental markings representing 60 minutes in an hour.

5. A watch bezel insert comprising a top surface having thereon a first set of indicia comprising a first plurality of incremental markings representing 24 hours in a day and a second set of indicia comprising a second plurality of incremental markings representing 60 minutes in an hour.
